(19) United States
(12) Patent Application Publication
(10) Pub. No.: US 2025/0005692 A1
(43) Pub. Date: Jan. 2, 2025

(54) LEGAL RESOURCES APPLICATION

(71) Applicant: Sajida Allyce Johnson, Coconut Creek, FL (US)

(72) Inventor: Sajida Allyce Johnson, Coconut Creek, FL (US)

(21) Appl. No.: 18/760,769

(22) Filed: Jul. 1, 2024

Related U.S. Application Data
(60) Provisional application No. 63/511,212, filed on Jun. 30, 2023.

(51) Int. Cl. G06Q 50/18

(52) U.S. Cl. CPC G06Q 50/18

(57) ABSTRACT

A method includes receiving a query from a user. The query includes at least one charge and jurisdiction associated with the charge, for example up to three charges in the jurisdiction. The method also includes retrieving, from a first database, laws and/or regulations of the jurisdiction. The method further includes retrieving, from a second database, the legal elements associated with the offenses charged. Additionally, the method includes retrieving, from a third database, defenses that can be raised for the offenses charged. The method includes retrieving, from a fourth database, one or more legal definitions associated with the offenses, defenses and elements. The method includes generating a plain language response based on the legal definitions, the offenses charged, the defenses, and one or more legal elements. Also, the method includes transmitting the plain language response to the user via the network.

### CROSS-REFERENCE TO RELATED APPLICATIONS

This application claims the benefit of priority of U.S. provisional application No. 63/511,212, filed Jun. 30, 2023, titled “Legal Resources Application,” the entire contents of which are herein incorporated by reference.

### FIELD

The present disclosure relates to databases and software applications and, more particularly, to legal resource databases and legal resource applications.

### BACKGROUND

Human society is governed by laws. However, most of these laws are buried in dense and lengthy legal codes written in difficult-to-understand legalese. Further, decisions in legal cases add to the complexity. Thus, most people have trouble understanding the law and, therefore, understanding what they should avoid doing to not break the law. Conventional legal resources allow people to look up existing cases, file legal papers with courts, or speak with their lawyers. However, no conventional resource breaks down the legal landscape into an easy-to-understand and plain English format that any person can use to understand their legal situation before spending money on legal fees.

As can be seen, there is a need for systems and methods that address the above drawbacks.

### SUMMARY

In one aspect of the present disclosure, a method includes receiving, by a processing device via a network, a query from a user. The query includes at least one charge and jurisdiction associated with the charge, for example up to three charges in the jurisdiction. The method also includes retrieving, from a first database, laws and/or regulations of the jurisdiction. The method further includes retrieving, from a second database, the legal elements associated with the offenses charged. Additionally, the method includes retrieving, from a third database, defenses that can be raised for the offenses charged. The method includes retrieving, from a fourth database, one or more legal definitions associated with the offenses, defenses and elements. The method includes generating a plain language response based on the legal definitions, the offenses charged, the defenses, and one or more legal elements. Also, the method includes transmitting the plain language response to the user via the network.

### BRIEF DESCRIPTION OF THE DRAWINGS

FIG. 1 is a system diagram of an environment of a database system, according to aspects of the present disclosure;

FIG. 2 is a diagram showing a process flow in a user device communicating with the database system, according to aspects of the present disclosure; and

FIG. 3 is a diagram showing a process flow in the database system, according to aspects of the present disclosure.

### DETAILED DESCRIPTION OF THE DISCLOSURE

The following detailed description is of the best currently contemplated modes of carrying out exemplary embodiments of the disclosure. The description is not to be taken in a limiting sense but is made merely for the purpose of illustrating the general principles of the disclosure, since the scope of the disclosure is best defined by the appended claims.

As discussed above, some people may find themselves in legal trouble and be given incomplete or incorrect information by police or lawyers. This can lead to people accepting plea deals because they do not know enough about the law to know that they have other options.

Broadly, an embodiment of the present disclosure provides a software application that breaks down the law at a selected level into easily understood plain English that allows people to understand what the law is and how to stay on the right side of it. For example, the software application allows individuals to review offenses at the state level and learn what is required to be charged with those offenses. The software application thus allows people to make informed decisions about the law and their own legal issues, such as when they are offered a plea deal that they should not take.

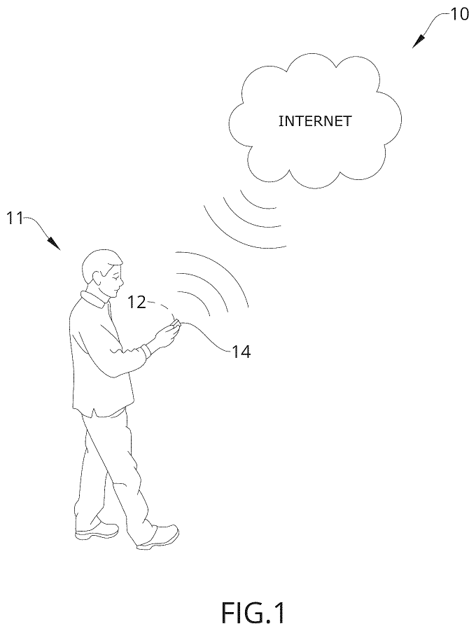

Referring now to FIG. 1-3, FIG. 1 illustrates an environment in which a user 11 can acquire information about legal matters from a database system, according to aspects of the present disclosure. While FIG. 1 illustrates examples of components of the database system, additional components can be added and existing components can be removed and/or modified.

As illustrated in FIG. 1, the user 11 can communicate with the database system using an application 12 stored and executed on a user device 14. The application 12 can communicate with the database system via one or more networks 10, e.g., Internet. The user device 14 can include one or more electronic devices such as a laptop computer, a desktop computer, a tablet computer, a smartphone, a thin client, and the like. In some embodiments, the application 12 can be a specifically designed application that operates with the user device 14 and the database system to perform the processes and methods described herein. In some embodiments, the application 12 can be a third-party application, such as a web browser, that communicates with the database system to perform the processes and methods described herein. The application 12 can include the necessary logic, instructions, and/or programming to perform the processes and methods described herein when executed on the user device 14. The application 12 can be written in any programming language.

For example, the application 12 that may be loaded onto the user device 14, e.g., local mobile device. The user 11 can log in to the application using a user interface of the user device 14. The user device 14 can then wirelessly, e.g., via Wifi or cellular data, connects to computing devices hosting the database system, e.g., at least one server, via the application 12. The database system includes a database of all laws for all jurisdictions in the United States, e.g., the fifty states, a database of the legal elements that must be proven for a person to be charged under each law and the defenses that can be raised for a respective law, a database of all possible charges that may be brought in each jurisdiction for each law in the jurisdiction, a database defining legal terms, and a database of attorneys who offer legal services through the application. The user 11 can search through the databases for relevant legal information by inputting searchable information into the application 12, such as charges or offenses, and the relevant jurisdiction. The application 12 then wirelessly connects to the database system and queries the database system for the relevant charges and jurisdiction. The database system locates the relevant charges and jurisdiction, reviews the relevant law for the jurisdiction, and returns to the elements of the charge that need to be proven to the application on the local device. The application 12 translates the elements of the charge into easily understood plain English using the database of legal definitions and presents the translated elements to the offense/charge and gives defenses that could be raised to the user 11. For example, the application may include and/or access machine learning algorithms (artificial intelligence) to translate the results into plain English.

The application 12 can then query the user 11 if the user 11 requires legal assistance. If the user responds that they require legal services, then the application 12 can open a chat function that allows the application to query the user about the user's legal needs and better determine what legal services are required and what attorney's are available to provide such services in the database of participating attorneys. Upon determining the best available attorneys based upon the user's needs, the application 12 provides a recommendation for attorneys to the user and provides the contact information for those attorneys. As such, database system providing the application 12 that breaks down the law at a selected level into easily understood plain English that allows people to understand what the law is and how to stay on the right side of it.

The application 12 can also include an update function stored on the database system that regularly searches publicly available information to retrieve the latest information regarding the law and legal definitions and updates the databases when a change has been made to the law or legal definitions.

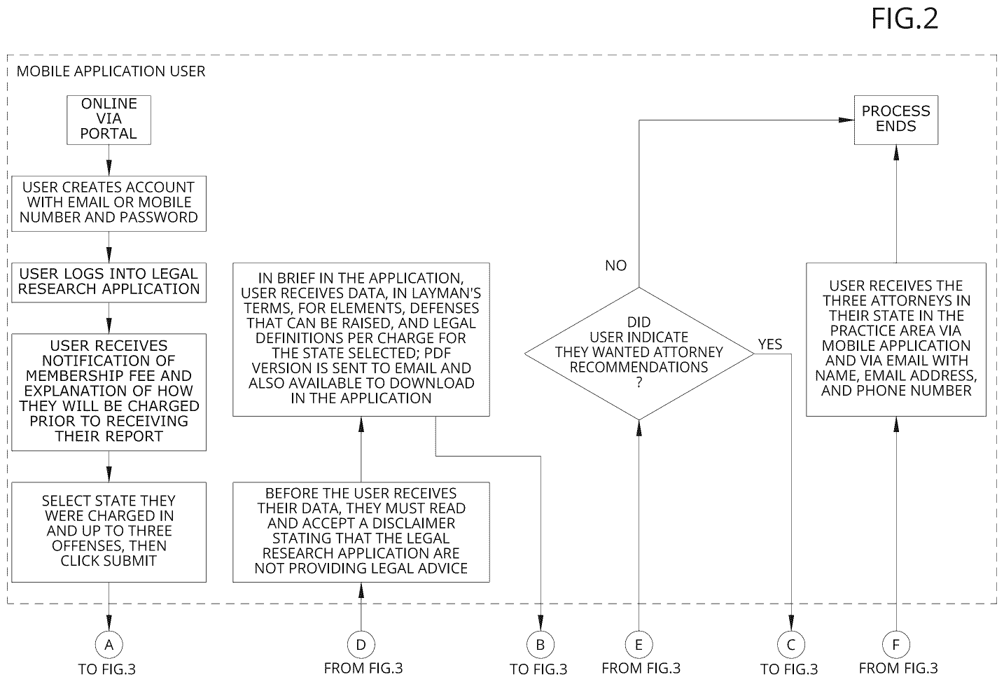

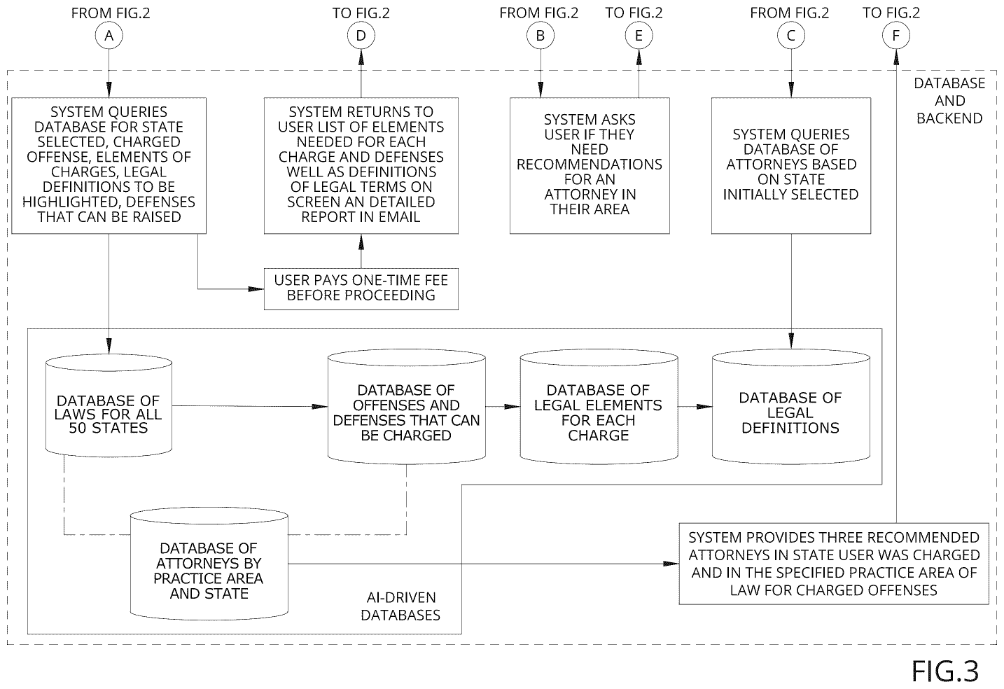

FIGS. 2 and 3 illustrate a process of using the database system from the user device side (FIG. 2) and the database system side (FIG. 3), according to aspects of the present disclosure. To begin, the user 11 logs into the application 12 using a user interface of the user device 12. The user device 12 connects to database system via the application 12. The database system includes a database of all laws for all jurisdictions in the United States, e.g., the fifty states, a database of the legal elements that must be proven for a person to be charged under each law and the defenses that can be raised for a respective law, a database of all possible charges that may be brought in each jurisdiction for each law in the jurisdiction, a database defining legal terms, and a database of attorneys who offer legal services through the application 12.

To search the databases, the application 12 prompts the user to enter in search information, preferably up to three offenses and the state or jurisdiction in which the offenses are being considered or applied. The application 12 then wirelessly connects to the database system and queries the databases within the database system for the relevant charges and jurisdiction. The database system locates the relevant charges and jurisdiction, reviews the relevant law for the jurisdiction, and returns the elements of the charge that need to be proven to the user via the application on the local device or via an email report to an email entered in by the user during a registration process for the application 12. The results from the database system are translated by the application into easily understood plain English using the database of legal definitions, such that the translated elements are presented to the user.

The application 12 can then query the user 11 if the user 11 requires legal assistance. If the user 11 responds that they require legal services, then the application 12 can open a chat function that allows the application 12 to query the user 11 about the user's legal needs and better determine what legal services are required and what attorneys are available to provide such services in the database of participating attorneys. Upon determining the best available attorneys based upon the user's needs, the application 12 provides a recommendation for attorneys to the user and provides the contact information for those attorneys.

In an illustrative example of the operation of the application 12, a user 11 may input a civil or criminal charge of negligence in the state of Wisconsin. The application 12 utilizes conditional logic gates to automatically query the databases on at least one server to only search Wisconsin law or law applicable within Wisconsin for negligence statutes and case law, the elements of those negligence statutes and case law, the defenses to the negligence statutes and case law, and the legal definitions database to translate the elements and defenses into plain English. The application 12 also recognizes when specific words may need greater explanation and highlights those words for the user 11, whereby the user 11 may select the word and receive a legal definition for that word. Further, the application 12 asks the user 11 if the user 11 needs legal help, and if the user states they need legal help, the application 12 then queries the attorney database on the at least one server for attorneys specializing in or experienced with criminal or civil negligence claims in the State of Wisconsin, depending on if the user's query was for civil or criminal negligence.

As such, the application 12 and database system breaks down the law at a selected level into easily understood plain English that allows people to understand what the law is and how to stay on the right side of it. Accordingly, the application 12 and database system provides ordinary people with the information they need to make more informed decisions about their legal situations. Additionally, for example, the application 12 and database system can be used as a research tool for law students, paralegals, or lawyers. The application 12 and database system allows legal students and professionals to quickly find charges, offenses, and defenses for writing briefs or responses to charges to be filed with the court, sent to opposing counsel, or for papers in school. The application 12 and database system can also be used as a study tool or educational refreshment tool for legal students and professionals.

The application 12 and database system for the provision of legal resources to the public described above is for purposes of example only and can be implemented in any type of computer system or programming or processing environment, or in a computer program, alone or in conjunction with hardware, as described below in further detail. The application 12 and database system can also be implemented in software stored on a computer-readable medium and executed as a computer program on a general purpose or special purpose computer. For clarity, only those aspects of the system germane to the invention are described, and product details well known in the art are omitted.

In the embodiments described above, any computing and/or electronic device, for example, the user device and/or the database system, can include a processing device coupled to a communication device. The processing device is also coupled to a memory device and an input/output (“I/O”) interface. In embodiments, the communication interface enables the computing and/or electronic device to communicate with other devices and systems via the one or more networks 10.

The processing device, the communication device, the memory device, and the I/O interface can be interconnected via a system bus. The system bus can be and/or include a control bus, a data bus, an address bus, and the like. The processing device 104 can be and/or include a processor, a microprocessor, a computer processing unit (“CPU”), a graphics processing unit (“GPU”), a neural processing unit, a physics processing unit, a digital signal processor, an image signal processor, a synergistic processing element, a field-programmable gate array (“FPGA”), a sound chip, a multi-core processor, and the like. As used herein, “processor,” “processing component,” “processing device,” and/or “processing unit” can be used generically to refer to any or all of the aforementioned specific devices, elements, and/or features of the processing device.

The memory device can be and/or include one or more computerized storage media capable of storing electronic data temporarily, semi-permanently, or permanently. The memory device can be or include a computer processing unit register, a cache memory, a magnetic disk, an optical disk, a solid-state drive, and the like. The memory device can be and/or include random access memory (“RAM”), read-only memory (“ROM”), static RAM, dynamic RAM, masked ROM, programmable ROM, erasable and programmable ROM, electrically erasable and programmable ROM, and so forth. As used herein, “memory,” “memory component,” “memory device,” and/or “memory unit” can be used generically to refer to any or all of the aforementioned specific devices, elements, and/or features of the memory device.

The communication device enables the computing and/or electronic device to communicate with other devices and systems. The communication device can include hardware and/or software for generating and communicating signals over a direct and/or indirect network communication link. As used herein, a direct link can include a link between two devices where information is communicated from one device to the other without passing through an intermediary. For example, the direct link can include a Bluetooth™ connection, a Zigbee connection, a Wifi Direct™ connection, a near-field communications (“NFC”) connection, an infrared connection, a wired universal serial bus (“USB”) connection, an ethernet cable connection, a fiber-optic connection, a firewire connection, a microwire connection, and so forth. In another example, the direct link can include a cable on a bus network. programming installed on a processor, such as the processing component, coupled to the antenna.

An indirect link can include a link between two or more devices where data can pass through an intermediary, such as a router, before being received by an intended recipient of the data. For example, the indirect link can include a WiFi connection where data is passed through a WiFi router, a cellular network connection where data is passed through a cellular network router, a wired network connection where devices are interconnected through hubs and/or routers, and so forth. The cellular network connection can be implemented according to one or more cellular network standards, including the global system for mobile communications (“GSM”) standard, a code division multiple access (“CDMA”) standard such as the universal mobile telecommunications standard, an orthogonal frequency division multiple access (“OFDMA”) standard such as the long-term evolution (“LTE”) standard, and so forth.

The computing and/or electronic device can communicate with one or more network resources via the network 10. The one or more network resources can include external databases, social media platforms, search engines, file servers, web servers, or any type of computerized resource that can communicate with the computing and/or electronic device via the network 116.

In embodiments, the components and functionality of the computing and/or electronic device can be hosted and/or instantiated on a “cloud” and/or “cloud service.” As used herein, a “cloud” and/or “cloud service” can include a collection of computer resources that can be invoked to instantiate a virtual machine, application instance, process, data storage, or other resources for a limited or defined duration. The collection of resources supporting a cloud can include a set of computer hardware and software configured to deliver computing components needed to instantiate a virtual machine, application instance, process, data storage, or other resources. For example, one group of computer hardware and software can host and serve an operating system or components thereof to deliver to and instantiate a virtual machine. Another group of computer hardware and software can accept requests to host computing cycles or processor time, to supply a defined level of processing power for a virtual machine. A further group of computer hardware and software can host and serve applications to load on an instantiation of a virtual machine, such as an email client, a browser application, a messaging application, or other applications or software. Other types of computer hardware and software are possible.

In embodiments, the components and functionality of the computing and/or electronic device can be and/or include a “server” device. The term server can refer to functionality of a device and/or an application operating on a device. The server device can include a physical server, a virtual server, and/or cloud server. For example, the server device can include one or more bare-metal servers such as single-tenant servers or multiple-tenant servers. In another example, the server device can include a bare metal server partitioned into two or more virtual servers. The virtual servers can include separate operating systems and/or applications from each other. In yet another example, the server device can include a virtual server distributed on a cluster of networked physical servers. The virtual servers can include an operating system and/or one or more applications installed on the virtual server and distributed across the cluster of networked physical servers. In yet another example, the server device can include more than one virtual server distributed across a cluster of networked physical servers.

Various aspects of the systems described herein can be referred to as “content” and/or “data.” Content and/or data can be used to refer generically to modes of storing and/or conveying information. Accordingly, data can refer to textual entries in a table of a database. Content and/or data can refer to alphanumeric characters stored in a database. Content and/or data can refer to machine-readable code. Content and/or data can refer to images. Content and/or data can refer to audio and/or video. Content and/or data can refer to, more broadly, a sequence of one or more symbols. The symbols can be binary. Content and/or data can refer to a machine state that is computer-readable. Content and/or data can refer to human-readable text.

The computing and/or electronic device can include a user interface for outputting information in a format perceptible by a user and receiving input from the user. The user interface can include a display screen such as a light-emitting diode (“LED”) display, an organic LED (“OLED”) display, an active-matrix OLED (“AMOLED”) display, a liquid crystal display (“LCD”), a thin-film transistor (“TFT”) LCD, a plasma display, a quantum dot (“QLED”) display, and so forth. The user interface can include an acoustic element such as a speaker, a microphone, and so forth. The user interface can include a button, a switch, a keyboard, a touch-sensitive surface, a touchscreen, a camera, a fingerprint scanner, and so forth. The touchscreen can include a resistive touchscreen, a capacitive touchscreen, and so forth.

It should thus be understood that the application or database system described above is not limited to any specific computer language, program, or computer. It is further contemplated that the present invention may be run on a stand-alone computer system or run from a server computer system that can be accessed by a plurality of client computer systems interconnected over an intranet network, or that is accessible to clients over the Internet. In addition, many embodiments described herein have application to a wide range of industries. To the extent the present disclosure discloses a system, the method implemented by that system, as well as software stored on a computer-readable medium and executed as a computer program to perform the method on a general purpose or special purpose computer, are within the scope of the present invention. Further, to the extent the present disclosure discloses a method, a system of apparatuses configured to implement the method are within the scope of the present invention.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements. As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And, an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

It should be understood, of course, that the foregoing relates to exemplary embodiments of the disclosure and that modifications can be made without departing from the spirit and scope of the disclosure as set forth in the following claims.

What is claimed is:

1. A method for adaptive research, comprising:
receiving, by a processing device via a network, a query from a user, the query including at least one charged offense and jurisdiction associated with the at least one charged offense;
retrieving, from a first database, laws and/or regulations for the jurisdiction;
retrieving, from a second database, one or more legal elements associated with the at least one charged offense;
retrieving, from a third database, one or more defenses that can be raised in response to associated with the at least one charged offense;
retrieving, from a fourth database, one or more legal definitions associated with the at least one charged offense, the one or more defenses, and the one or more legal elements;
generating a plain language response based on the one or more legal definitions, the at least one charged offense, the one or more defenses, and the one or more elements; and
transmitting the plain language response to the user via the network.

2. The method of claim 1, wherein the plain language response comprises a list of legal elements from one or more legal elements that are needed to prove the at least one charged offense and one or more definitions of legal terms.

3. The method of claim 1, wherein the plain language response comprises a list of defenses from the one or more defenses that can be raised in response to the at least one charged offense.

4. The method of claim 1, further comprising:
receiving a request for an attorney recommendation;
retrieving, from a fifth database, contact information for at least one attorney located in the jurisdiction and knowledgeable of the at least one charged offense; and
transmitting the contact information to the user.

5. The method of claim 4, further comprising:
transmitting the plain language response to the at least one attorney.

6. The method of claim 1, further comprising:
generating a document comprising a detailed legal analysis of the at least one charged offense; and
transmitting the document to the user.

7. The method of claim 6, further comprising:
transmitting the document to an attorney retained by the user.

8. The method of claim 1, wherein the query includes up to three charged offenses.
